(19) United States
(12) Patent Application Publication
(10) Pub. No.: US 2008/0290578 A1
(43) Pub. Date: Nov. 27, 2008

(54) IMAGE RECORDING APPARATUS AND SHEET SEPARATING/CUTTING METHOD THEREBY

(75) Inventor: Toshiyuki EBIHARA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/117,168

(22) Filed: May 8, 2008

(30) Foreign Application Priority Data
May 21, 2007 (JP) 2007-134174

(51) Int. Cl. B41F 13/58

(52) U.S. Cl. 270/5.02

(57) ABSTRACT

This is an image recording apparatus for cutting a continuous sheet by a sheet cutting unit after recording images on the continuous sheet, which comprises: a defect detecting unit for detecting a defective image recorded on the continuous sheet; and a sheet cutting position control unit for modifying cutting conditions and enabling the sheet cutting unit to cut the continuous sheet, based on a detection result of the defect detecting unit.

### CROSS REFERENCE TO RELATED APPLICATIONS

This application is based upon and claims the benefit of priority from the prior Japanese Patent Application No. 2007-134174, filed May 21, 2007, the entire contents of which are incorporated herein by reference.

### BACKGROUND OF THE INVENTION

1. Field of the Invention

The present invention relates to an image recording apparatus for recording images on the continuous sheet of a recording medium, and more particularly to the cutting method of the continuous sheet for classifying the continuous sheet after recording the images.

2. Description of the Related Art

Recently, non-litho printing has been widely used especially for a fairly small amount of printing because of its advantages of low running costs and a short delivery time.

In such non-litho printing, an ink-jet recording method is known as one of the most suitable ink-jet recording methods. The ink-jet recording method uses a nozzle array (recording head) having a lot of fine nozzles for jetting ink.

In such a nozzle array, for example, when ink is contaminated with a foreign material, in some parts ink cannot be normally jetted sometimes to cause a defect in the printing result since the nozzle is stopped and so on.

In such a case, since a normally printed sheet (recording medium) and a defective printed sheet are mixed, the sheet having a defect must be separated and removed.

If such separation is manually performed, every sheet must be checked with eyes on whether it is defective. In this case, workability is bad and sometimes there occurs an oversight in the check.

Technologies for automating such separation work are proposed, for example, by Patent Document 1 (Japanese Patent Application No. 2001-270648) and Patent Document 2 (Japanese Patent Application No. 2003-237157).

Patent Document 1 discloses a printer configured to automatically remove a misprinted part from a normally printed part in the cutting process of the discharge of a piece of recording paper and its paper discharge method.

In this method of Patent Document 1, if a sheet is normally printed, it is cut every frame and if it is misprinted, misprinted part is cut with the shorter amount of conveyance than this. Thus, in the case of normal printing, since a piece of recording paper is conveyed and reaches a discharge outlet, the recording paper is discharged from the printer. However, the misprinted part of the recording paper drops into a dust box inside the printer and never reaches the discharge outlet.

As described above, in Patent Document 1, only pieces of normally printed recording paper are discharged from the printer and a piece of normally printed recording paper is separated from a piece of misprinted recording paper.

Patent Document 2 discloses an ink-jet printer capable of automatically removing a defective part, such as a joint in which pieces of roll paper are jointed and the like.

In this method of automatically removing defective parts in the ink-jet printer disclosed by Patent Document 2, if a detection sensor detects a defective part, the recording paper is cut before or after the defective part to produce a cut piece of the recording paper including the defective part, which is collected.

As described above, the ink-jet printer of Patent Document 2 automatically separates the part of a piece of rolled paper in which images are normally recorded from its defective part.

### SUMMARY OF THE INVENTION

The image recording apparatus in one aspect of the present invention cuts the continuous sheet by a sheet cutting unit after recording images on a continuous sheet. The image recording apparatus comprises a defect detecting unit for detecting the defective image recorded on the continuous sheet, and a sheet cutting position control unit for modifying cutting conditions based on the detection result of the defect detecting unit and enabling the sheet cutting unit to cut the continuous sheet.

The sheet separating/cutting method in another aspect of the present invention comprises detecting the defective image recorded on the continuous sheet, and modifying cutting conditions based on the detection result of the defect detecting unit and enabling the sheet cutting unit to cut the continuous sheet.

### BRIEF DESCRIPTION OF THE DRAWINGS

FIG. 1 is a block diagram showing a configuration example of the image recording apparatus of this preferred embodiment conceptually.

FIG. 2 is a typical disposition example of components constituting the image recording apparatus of this preferred embodiment.

FIG. 3A shows a case where one variable (amount of conveyance) (CA) and another variable (defect flag) (DF) in a state before the e defect detecting unit detects a defect on a sheet.

FIG. 3B shows a case where one variable (amount of conveyance) (CA) and another variable (defect flag) (DF) in a state immediately after the defect detecting unit has detected the defect on the sheet.

FIG. 3C shows a case where one variable (amount of conveyance) (CA) and another variable (defect flag) (DF) in a state after the defect detecting unit has detected the defect on the sheet.

FIG. 4 is a flowchart showing the operating process of a first thread in a control program including the sheet separating/cutting method of this preferred embodiment.

FIG. 5 is a flowchart showing the operating process of a second thread in a control program including the sheet separating/cutting method of this preferred embodiment.

FIG. 6 shows the cutting position on a sheet.

FIG. 7 shows another example of how to cut a sheet.

FIG. 8 shows a sheet reception unit and a sheet received in the sheet reception unit.

### DESCRIPTION OF THE PREFERRED EMBODIMENT

The preferred embodiment of the present invention is described in detail below with reference to the drawings.

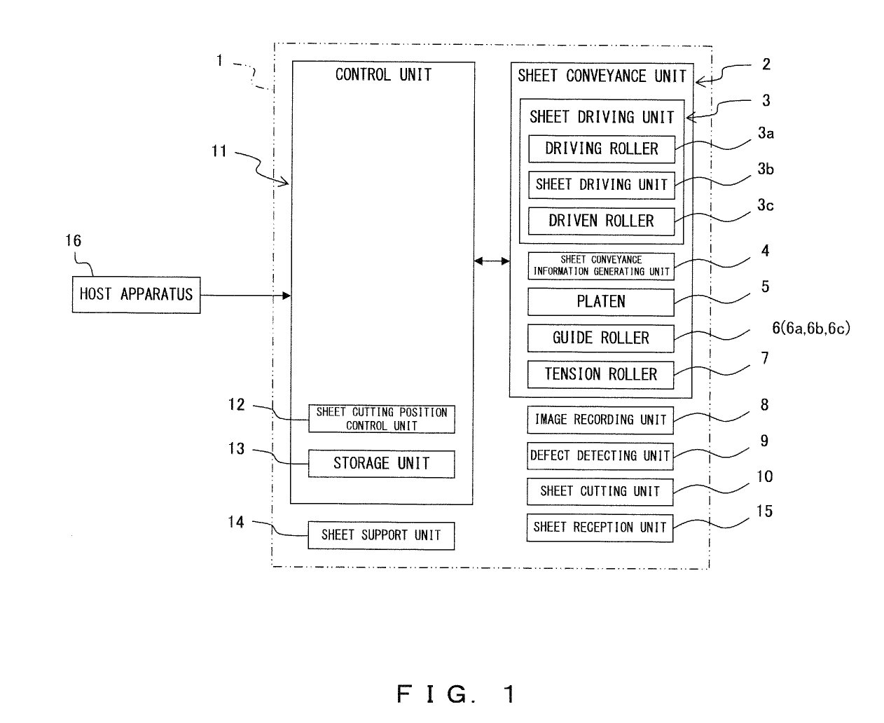

FIG. 1 is a block diagram showing a configuration example of the image recording apparatus of this preferred embodiment conceptually.

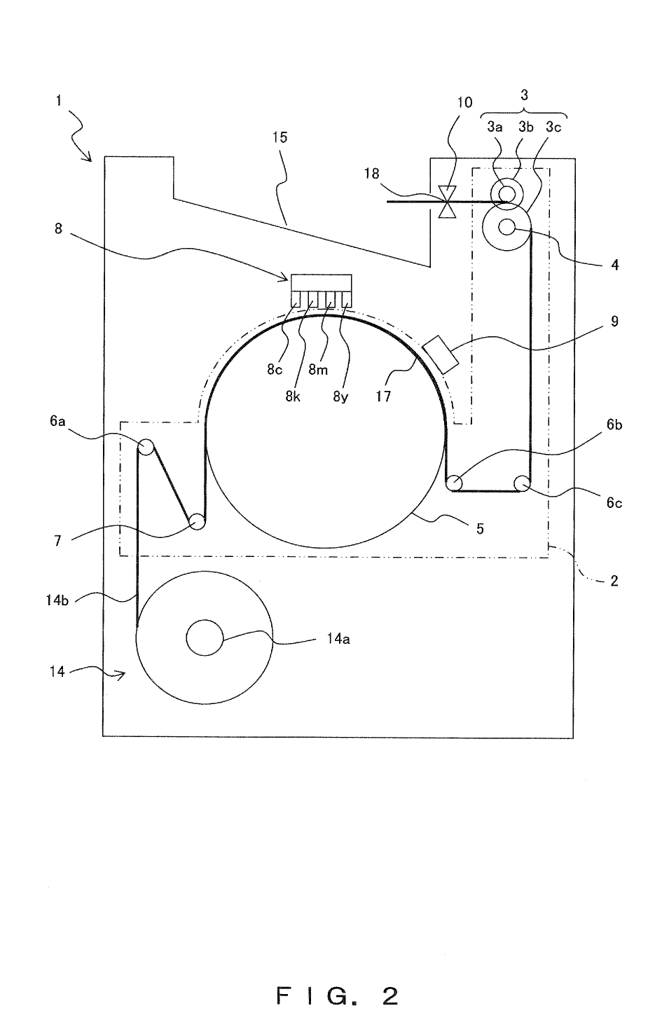

FIG. 2 is a typical disposition example of components constituting the image recording apparatus of this preferred embodiment.

The image recording apparatus 1 of this preferred embodiment comprises at least a sheet conveyance unit 2, an image recording unit 8, a defect detecting unit 9, a sheet cutting unit 10, a control unit 11 and a sheet reception unit 15.

The sheet conveyance unit 2 comprises a sheet driving unit 3, a sheet conveyance information generating unit 4, a platen 5, a guide roller 6, a tension roller 7 and the like.

The image recording apparatus 1 further comprises a sheet support unit 14 comprising a sheet support pivot 14a and a continuous sheet 14b, and the continuous sheet 14b in a long recording medium on which images are recorded can be attached/detached to/from the sheet support pivot 14a.

The control unit 11 comprises at least a processing circuit composed of, for example, MPU (microprocessor unit) as an operation processing device having, for example, a control function and an operation function, ROM (read-only memory) for storing a control program, RAM (random-access memory) as a work memory of the MPU and the like and non-volatile memory for storing setting values for controlling the image recording apparatus 1. The ROM is composed of un-rewritable mask ROM, rewritable flash ROM and the like.

The control unit 11 also comprises at least a sheet cutting position control unit 12 for separating and cutting a defective sheet and a storage unit 13 for storing various settings and the like in advance. The storage unit 13 of the control unit 11 is composed of non-volatile memory. The control unit 11 works as the sheet cutting position control unit 12 by storing a control program, for example, in ROM in advance and making the MPU read and execute the control program.

In the image recording apparatus 1 of this preferred embodiment, for example, the sheet cutting position control unit 12 can also be constituted as the dedicated logic circuit of the control unit 11 and its control can be realized by executing a control program by MPU for controlling the dedicated logic circuit which is stored in ROM in advance.

The continuous sheet 14b fed from the sheet support unit 14 reaches the sheet cutting unit 10 via the guide roller 6a, the tension roller 7, the platen 5 and guide roller 6b and guide roller 6c and the sheet drive unit 3.

The guide roller 6a constitutes the conveyance route of the continuous sheet 14b, loosens the winding of the continuous sheet 14b supported by the sheet support pivot in a rotatable state and leads it to the lower reach side of the conveyance route. The tension roller 7 gives tension to the continuous sheet 14b in such a way that the continuous sheet 14b can stick to the platen 5. The platen 5 is rotated, for example, by the power of a motor, which is not shown in FIG. 2, to carry the continuous sheet 14b fed from the sheet support unit 14 to the lower reach side of the conveyance route. The sheet drive unit 3 comprises a driving roller 3a, a sheet drive unit 3b and a driven roller 3c. The sheet drive unit 13 pinches the continuous sheet 14b carried by the platen 5 with the driving roller 3a and the driven roller 3c and carries the continuous sheet 14b to the lower reach side of the conveyance route by rotating the driving roller 3a by the power of, for example, the motor 3b in the sheet drive unit 3b.

The sheet conveyance information generating unit 4 generates information indicating the amount of conveyance of the continuous sheet 14b (sheet conveyance signal) from the amount of rotation of the driven roller 3c, for example, by a rotary encoder attached to the rotation shaft of the driven roller 3c of the sheet drive unit 3 and outputs it to the control unit 11. This sheet conveyance information generating unit 4 outputs one sheer conveyance pulse signal to the control unit 11 every time the continuous sheet 14b advances, for example, 0.1 mm.

This sheet conveyance information generating unit 4 can be also attached to the platen 5 or the like.

The image recording unit 8 comprises a nozzle array composed of a plurality of nozzles (8c, 8k, 8m and 8y), for jetting ink according to inputted image data and records images on the continuous sheet 14b with ink drops jetted from the nozzle.

The nozzle array (8c, 8k, 8m and 8y) records color images on the continuous sheet 14b by jetting, for example, cyan, black, magenta and yellow ink.

Although the image recording apparatus 1 shown in FIG. 2 are configured to have a nozzle array corresponding to four colors of ink, the configuration of the image recording apparatus 1 of this preferred embodiment is not limited to this. For example, images can be also recorded with single color of ink. Alternatively, a nozzle array corresponding to five colors or more of ink can be provided and images can be recorded using the five colors or more of ink.

The defect detecting unit 9 checks whether there is a defect in printing (image recording), at a defect detecting point being an arbitrary position in the continuous sheet 14b and notifies the control unit 11 of the check result upon request from the control unit 11. The defect detection can be realized, for example, by the method disclosed in Japanese Patent Application No. 2001-277676.

The method by the Japanese Patent Application No. 2001-277676 detects a defect by comparing and referring a pattern read from a recording medium on which images are printed by a CCD sensor and a verification pattern.

Although the system disclosed by the Japanese Patent Application No. 2001-277676 comprises an image recording apparatus, a pre-treatment device for generating a verification pattern and a verification device for detecting a defect separately, in this preferred embodiment the image recording apparatus 1 has functions corresponding to the pre-treatment device and the verification device.

The sheet cutting unit 10 cuts the continuous sheet 14b at a cutting point (see reference number 18 shown in FIG. 2) along the width direction, based on a sheet cutting signal from the control unit 11.

A host apparatus 16 is external equipment connected to the image recording apparatus 1 via a LAN or the like. This host apparatus 16 corresponds to a user's computer for making the image recording apparatus 1 to record images and notifies the control unit 11 of the image recording apparatus 1 of this preferred embodiment of information about image record and instruction information, such as image record start and the like.

Next, the operating process of the sheet cutting position control unit 12 of the control unit 11 is described.

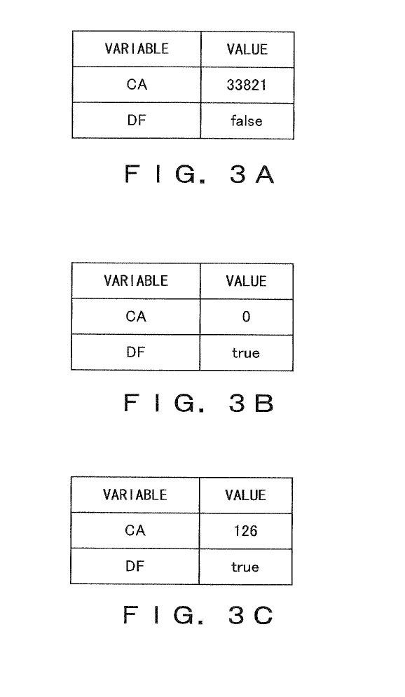

FIG. 3A shows a case where one variable (amount of conveyance) (CA) and another variable (defect flag) (DF) in a state before the defect detecting unit detects a defect on a sheet. FIG. 3B shows a case where one variable (amount of conveyance) (CA) and another variable (defect flag) (DF) in a state immediately after the defect detecting unit has detected the defect on the sheet. FIG. 3C shows a case where one variable (amount of conveyance) (CA) and another variable (defect flag) (DF) in a state after the defect detecting unit has detected the defect on the sheet.

In FIGS. 3A, 3B and 3C, the variable CA indicates the amount of conveyance of the continuous sheet 14b after the defect detecting unit 9 detects a defect on the continuous sheet 14b. This variable CA is updated on the basis of a signal transmitted from the sheet conveyance information generating unit 4. The variable CA increases its value by one in the storage unit 13 of the control unit 11 by the sheet conveyance information generating unit 4 transmitting a sheet conveyance signal every time the continuous sheet 14b advances, for example, 0.1 mm.

The variable DF is Boolean type one for indicating whether the defect detecting unit 9 has detected a defect and takes a value either “true” or “false”. When taking a value “false”, the variable DF indicates that the defect detecting unit 9 detects no defect in image recording and when taking a value “true”, it indicates that the defect detecting unit 9 has detected a recorded defective image.

In FIG. 3A, since the defect detecting unit 9 has not detected a defect, the variable DF takes a value “false”. In FIG. 3B, since the defect detecting unit 9 has detected a defect immediately before, the variable DF takes a value “true” and the variable CA is reset to a value “zero”. In FIG. 3C, since a state where the continuous sheet 14b is carried even after defect detecting unit 9 has detected a defect, the variable DF takes a value “true” and the variable CA indicates the amount of conveyance of the continuous sheet 14b after detecting the defect.

Next, the operating processes of first and second threads in a control program including the sheet separating/cutting method of this preferred embodiment are described.

In this description of the control program including the sheet separating/cutting method, as described earlier, it is assumed that the control unit 11 is functioned as the sheet cutting position control unit 12 by the MPU of the control unit 11 reading and executing a control program stored in ROM in advance. When image recording is started in the image recording apparatus 1 of this preferred embodiment, the operating processes of the first and second threads are executed in parallel.

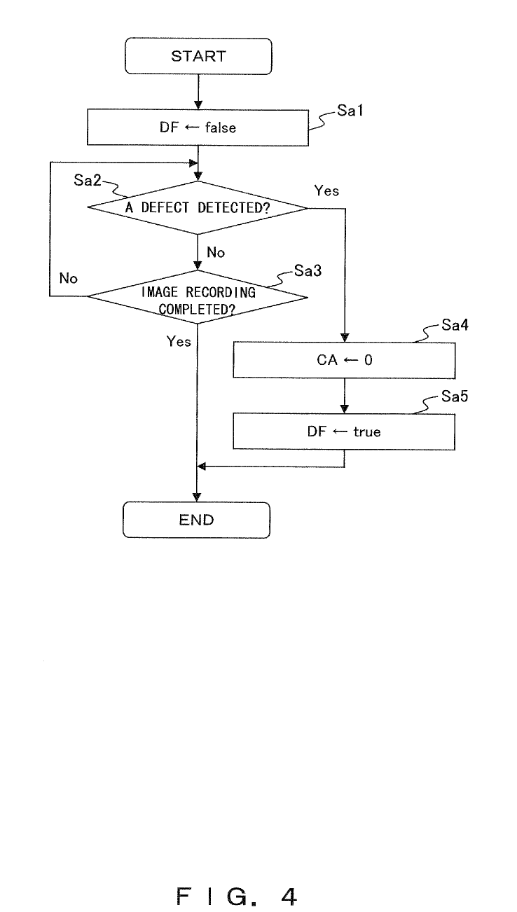

FIG. 4 is a flowchart showing the operating process of the first thread in a control program including the sheet separating/cutting method of this preferred embodiment.

In the first thread, when image recording is started, firstly in step Sa1 the control unit 11 sets the value of the variable DF in its own storage unit 13 to a state “false” indicating that no defect is detected as a result of the image recording.

Then, in the first thread, in step Sa2 the control unit 11 inquires the defect detecting unit 9 of whether a defect is detected the defect detecting unit 9.

If receiving a reply that no defect is not detected from the defect detecting unit on this moment (No in step Sa2), the control unit 11 advances the process to step Sa3 to check whether the image recording is completed.

If determining in step Sa3 that the image recording is not completed (No in step Sa3), the control unit 11 returns the process to step Sa2. If determining the image recording is completed, the control unit 11 terminates the operating process of this first thread. If notified that a defect has been detected by the defect detecting unit 9 in step Sa2, the control unit 11 advances the process to step Sa4 to reset the variable CA stored in the storage unit 13 to a value “zero”. Then, in step Sa5 the control unit 11 terminates the operating process of the first thread after setting the variable DF stored in the storage unit 13 to “true”.

In the first thread when the defect detecting unit 9 detects a defect during the image recording, “true” is set in the variable DF to indicate that a defect has been detected in the image recording, and the variable CA is reset to “zero”. Thus, the variable CA indicates the amount of conveyance (length) of the continuous sheet after the defect has been detected.

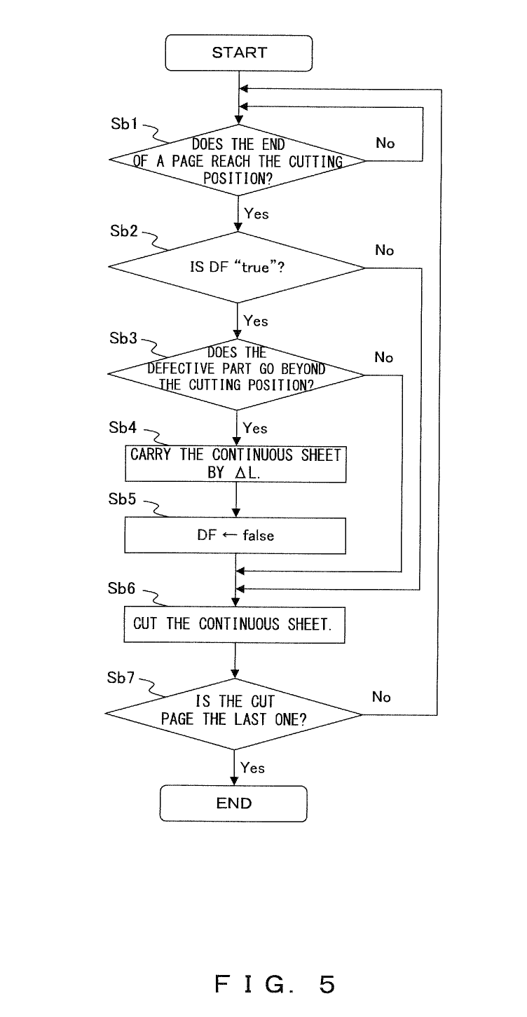

FIG. 5 is a flowchart showing the operating process of the second thread in a control program including the sheet separating/cutting method of this preferred embodiment.

When image recording by the image recording apparatus 1 is started, the second thread is activated together with the first thread. In the second thread, firstly in step Sb1 the control unit 11 checks whether the end of a page reaches a sheet cutting point 18. If determining that the end of a page does not reach the cutting point (No in step Sb1), the control unit 11 returns the process to step Sb1 and waits until the end of a page reaches the sheet cutting point 18. The control unit 11 can determine whether the end of a page reaches the sheet cutting point 18 by pursuing the movement of the end of each page following sheet conveyance. The determination in step Sb1 is made by calculating the amount of conveyance of the continuous sheer 14b by the sheet conveyance information generating unit 4.

If determining in step Sb1 that the end of a page reaches the sheet cutting point 18 (Yes in step Sb1), the control unit 11 advances the process to step Sb2 to check the value of variable DF stored in the storage unit 13. If determining that the value of the variable DF is “false” (No in step Sb2), the control unit 11 skips the process to step Sb6 since no defect is not detected.

If determining in step Sb2 that the value of the variable DF is “true” as a result (Yes in step Sb2), the control unit 11 advances the process to step Sb3 to determine whether the defective part goes beyond the cutting point. Specifically, the control unit 11 performs the determination in step Sb3 only when a defect has been detected in the image detection.

The determination in step Sb3 is performed as follows.

In this case, the distance L0 of a sheet route from the defect detecting point 17 to the sheet cutting point 18 is longer than the sheet length of one page. This value L0 is stored in the storage unit 13 of the control unit 11.

In the second thread, in step Sb3 it is determined whether the part on the continuous sheet 14b in which a defect is detected in image recording goes beyond the sheet cutting point 18. This determination is made by comparing length indicated by the value of the variable CA with L0.

Specifically, if the control unit 11 determines that the value of the variable CA more than L0 (L0<CA), it is determined that the part on the continuous sheet 14b in which a defect is detected in image recording goes beyond the sheet cutting point 18. If the control unit 11 determines that the value of the variable CA is equal to or less than L0 (L0≧CA), the part on the continuous sheet 14b in which a defect is detected in image recording does not go beyond the sheet cutting point 18.

If determining that the part on the continuous sheet 14b in which a defect is detected in image recording goes beyond the sheet cutting point 18 (Yes in step Sb3), the control unit 11 advances the process to step Sb4. If not determining that the part on the continuous sheet 14b in which a defect is detected in image recording goes beyond the sheet cutting point 18 (No in step Sb3), the control unit 11 skips the process to step Sb6. Specifically, the control unit 11 performs the processes in steps Sb4 and Sb5 only when the part in which a defect is detected goes beyond the sheet cutting point 18 by the sheet conveyance.

In this case, it is assumed that the length of one page in the case where a sheet on which images are normally recorded is cut, the length of one page in the case where a first sheet including a defect is cut, and a difference between them are L1, L2 and ΔL, respectively. Specifically, it is assumed that L2−L1=ΔL. The image recording apparatus 1 of this preferred embodiment stores this value ΔL, for example, in the storage unit 13.

The value ΔL can be appropriately set. In this description, it is assumed that ΔL=10 mm.

Thus, in the image recording apparatus 1 of this preferred embodiment, the length of the sheet of the first page including a recorded defective image is 10 mm longer than the length of a sheet on which images are normally recorded.

In the second thread, in step Sb4 the control unit 11 refers to a sheet conveyance signal from the sheet conveyance information generating unit 4 and carries the continuous sheet 14b by ΔL.

One sheet conveyance signal is inputted to the control unit 11 from the sheet conveyance information generating unit 4 every time the continuous sheet 14b is carried, for example, by 0.1 mm. Since in the case where ΔL=10 mm, 10/0.1=100, the continuous sheet 14b is carried while 100 sheet conveyance signals are inputted.

After carrying the sheet by ΔL, in step Sb5 the control unit 11 sets the value of the variable DF to “false”.

Then, in step Sb6 the control unit 11 transmits a sheet cutting signal to the sheet cutting unit 9 to cut the continuous sheet 14b.

Then, in step Sb7 the control unit 11 determines whether the end of the last page is cut.

In this case, the control unit 11 determines whether the end of the last page is cut by storing the number of pages on which images should be recorded and the number of pages on which images are recorded.

If in step Sb7 determining that the end of the last page is not cut yet (No in step Sb7), the control unit 11 returns the process to step Sb1. If determining that the end of the last page is cut (Yes in step Sb7), the control unit 11 terminates the process of the second thread.

In this case, the earlier-described processes shown in FIG. 4 flows step Sa4 to step Sa5 further to END and the number of times the first thread sets the value of the variable DF to “true” is 0 or 1. Therefore, if in the second thread, in step Sb5 the value of the variable DF is set to “false”, the value of the variable DF never becomes “true” until the image recording is terminated after that.

Thus, the control unit 11 cuts only the sheet of the first page including a recorded defective image with the length L2 and cuts the sheets of pages after it with the same length L1 as the sheet on which images are normally recorded without performing step Sb3 and Sb4 that are performed once.

In the image recording apparatus 1 of this preferred embodiment, step Sb6 can be also removed and the continuous sheet 14b including a defect after it can also cut longer than the continuous sheet 14b on which images are normally recorded. Although in either case the cutting position deviates from the partition of images after the first page including a defect, in many cases, the defective image continues until the nozzle is recovered. Therefore, there is usually no problem even if the cutting position deviates from the partition. If the cutting position and the partition of images are desired to match each other, the cutting position and the partition of images can be also matched after the third image by cutting the second image after they are deviated, short.

In the image recording apparatus 1 of this preferred embodiment, if in step Sb2 “true” is set to the variable DF, the process of the second thread can be also terminated to cancel image recording after it without performing the process in step Sb7 when the continuous sheet 14b of a page on which a defect is detected.

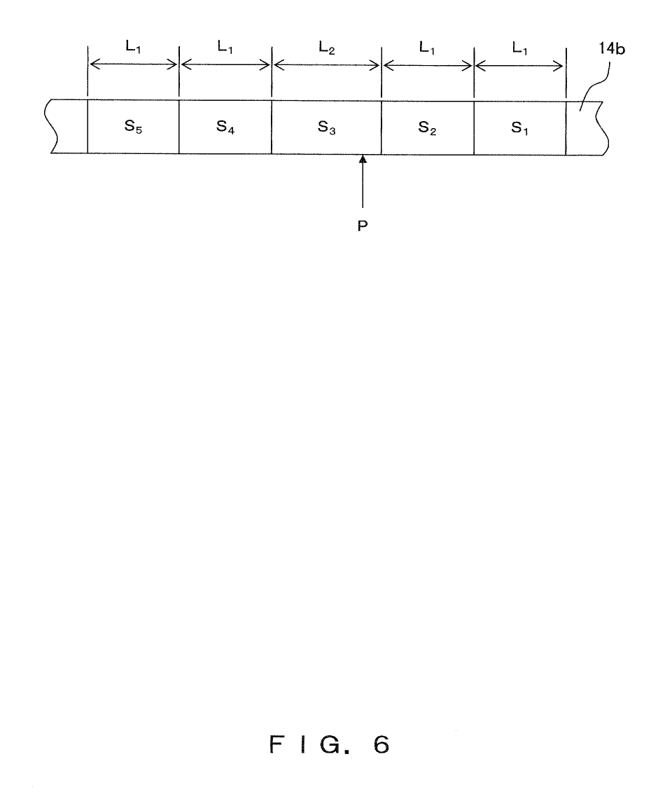

FIG. 6 shows the cutting position on the continuous sheet 14b.

In FIG. 6, the continuous sheet 14b is carried rightward and sequentially cut from the right end.

In FIG. 6, S1 and S2 indicate pages on which images are normally recorded. These pages are cut with the length L1.

A position P on the continuous sheet 14b indicates the position of a detected defect in image recording.

A page S3 including this defect is cut with the length L2 longer than the length L1 of a normal page. Then, pages S4 and S6 after this page S3 are cut with the length L1.

Although in the image recording apparatus 1 of this preferred embodiment, as shown in FIG. 6, the first page S3 including a defect is cut longer than a page on which images are normally recorded across the entire width of the continuous sheet 14b, the cutting method of this image recording apparatus 1 is not limited to this. It can be also cut in such a way that a part of the continuous sheet 14b may become longer, instead of cutting it across the entire width.

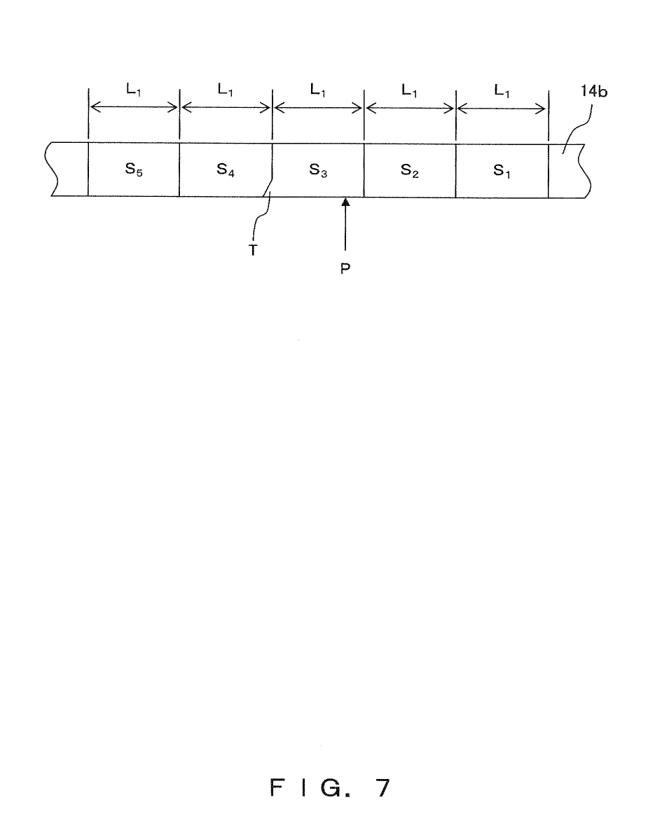

Such an example is shown in FIG. 7.

In FIG. 7, the same reference numerals as shown in FIG. 6 are attached to the same components.

In FIG. 7, although the first page S3 including a recorded defective image is cut with the same length L1 as other pages, only a part indicated by T is cut longer than L1.

By this part indicated by T, it is known that page 3 is the first page including a defect.

As another method, the cross section of a page on which a defect is detected can be also obliquely cut in the width direction of the continuous sheet 14b.

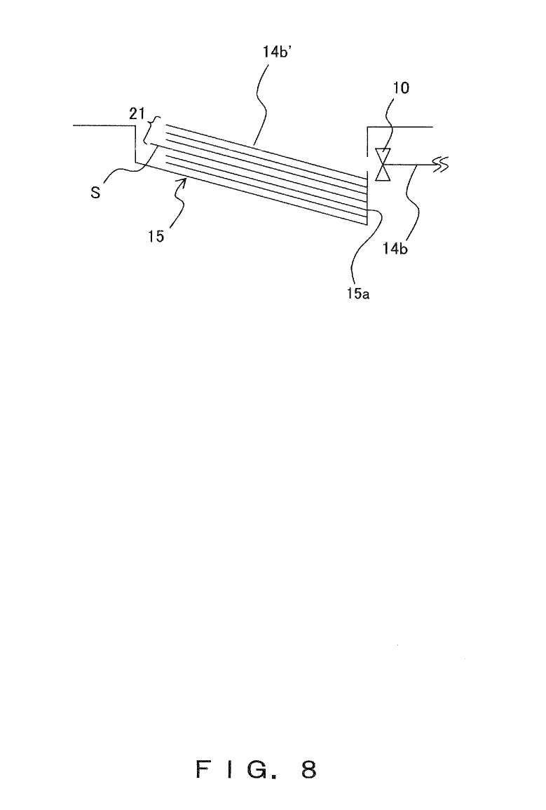

FIG. 8 shows the sheet reception unit 15 and the sheet 14b′ received in the sheet reception unit 15.

As shown in FIG. 8, the cut sheet 14b′ is mounted on and received in the sheet reception unit 15.

The sheet reception unit 15 can have, for example, an obliquely inclined bottom and the sheet 14b′ is received in such a way one ends of the sheet 14b′ can be uniformly arranged at an edge 15a by its own weight when receiving the sheet 14b′ cut by the sheet cutting unit 10 in the sheet reception unit 15.

Thus, a longer sheet 14b′ indicated by S can be easily separated by eyes. Therefore, since the longer sheet 14b′ indicated by S is the first sheet 14b′ including a defect, there is a possibility that a defect may be included in a part 21 upper than this of the sheet 14b′. By removing this part of the sheet 14b′, a user can separate a sheet 14b′ on which images are normally recorded from a sheet 14b′ including a defect.

As described above, according to the image recording apparatus 1 of this preferred embodiment, a sheet 14b′ including a defect can be separated by its cutting method.

Although the ink-jet image recording apparatus 1 of this preferred embodiment has been described above, the present invention is not limited to this and the present invention can be applied to various types of image recording apparatus, such as a laser recording type one.

Although in the image recording apparatus 1 of this preferred embodiment, a rolled sheet is used as one example of a continuous sheet, the present invention is not limited to this and it can be a long sheet instead of a rolled one.

What is claimed is:

1. An image recording apparatus for cutting a continuous sheet by a sheet cutting unit after recording images on the continuous sheet, comprising:
a defect detecting unit for detecting a defective image recorded on the continuous sheet; and
a sheet cutting position control unit for modifying cutting conditions and enabling the sheet cutting unit to cut the continuous sheet, based on a detection result of the defect detecting unit.

2. The image recording apparatus according to claim 1, further comprising:
an operation processing device; and
a control unit comprising at least an operation processing device and a storage unit for storing a control program in advance,
wherein
the control unit functions as the sheet cutting position control unit by enabling the operation processing device to executing the control program.

3. The image recording apparatus according to claim 1, wherein
when the defect detecting unit does not detect the defect, the sheet cutting position control unit enables the sheet cutting unit to cut the continuous sheet with a prescribed length and
when the defect detecting unit detects the defect, the sheet cutting position control unit enables the sheet cutting unit to cut the continuous sheet with longer length than the prescribed length.

4. The image recording apparatus according to claim 3, wherein
the sheet cutting position control unit enables the sheet cutting unit to cut the continuous sheet with longer length than the prescribed length after the defect detecting unit detects the defect.

5. The image recording apparatus according to claim 1, wherein
when the defect detecting unit does not detect the defect, the sheet cutting position control unit enables the sheet cutting unit to cut the continuous sheet with a prescribed length and
when the defect detecting unit detects the defect, the sheet cutting position control unit enables the sheet cutting unit to cut the continuous sheet in unparallel with width direction of the continuous sheet.

6. The image recording apparatus according to claim 1, wherein
when the defect detecting unit does detect the defect, the sheet cutting position control unit enables the sheet cutting unit to cut the continuous sheet in such a way that a part of it may become longer than the prescribed length.

7. The image recording apparatus according to claim 1, further comprising
a sheet reception unit having an edge and an inclined bottom, for receiving the continuous sheet in such a way one ends of the continuous sheet cut by the sheet cutting unit at the edge can be uniformly arranged by its own weight.

8. A sheet separating/cutting method by an image recording apparatus for cutting a continuous sheet by a sheet cutting unit after recording images on the continuous sheet, comprising:
detecting a defective image recorded on the continuous sheet; and
modifying cutting conditions and enabling the sheet cutting unit to cut the continuous sheet, based on the defection result.

9. The sheet separating/cutting method according to claim 8, wherein
cutting the continuous sheet with a prescribed length when not detecting the defect as the detection result and
cutting the continuous sheet in a different cutting method from when not detecting the defect when detecting the defect.
